(19) United States
(12) Patent Application Publication
(10) Pub. No.: US 2005/0131808 A1
(43) Pub. Date: Jun. 16, 2005

(54) Method for establishing control over credit card transactions

(76) Inventor: Edgar Villa, San Jacinto, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/733,433

(22) Filed: Dec. 10, 2003

(51) Int. Cl. G06F 17/60

(52) U.S. Cl. 705/39

(57) ABSTRACT

A method for controlling credit card transactions includes establishing a transaction supporting banking account, a credit limit, and an active account portion of the banking account. Credit card transactions are limited to the active account through valid requests. Each transaction includes, validating a user credit card prior to the transaction and then presenting, audibly or on screen; activity options including: Card Balance Inquiry, Credit Line Limit Inquiry, Transfer Amount, Transaction History, Account History, and Set Zero Balance. By selecting one of the options the user may display a balance in the active account; a credit limit and a balance in the active account; possible transfer amount choices, a list of card transaction amounts or a list of credit transfers into the active account with corresponding dates and times of execution, and may set the active account balance to zero.

### BACKGROUND OF THE INVENTION

1. Incorporation by Reference

Applicant(s) hereby incorporate herein by reference, any and all U.S. patents, U.S. patent applications, and other documents and printed matter cited or referred to in this application.

2. Field of the Invention:

This invention relates generally to banking methods and the use of bank credit cards and debit cards, and more particularly to a method for controlling bank balances so that misuse and fraud is avoided in credit card usage.

3. Description of Related Art

The following art defines the present state of this field:

Mansvelt et al., U.S. Pat. No. 5,175,416 describes a method of transferring funds including the steps of linking a first “smart card” to a first financial institution, debiting an account held at the financial institution and recording a corresponding credit value in the first smart card. The first smart card is then linked to a second, similar device, the credit value in the first device is reduced, and a corresponding credit value is recorded in the second device. The second device is then linked to a second financial institution, the credit value in the second device is reduced, and a corresponding credit value is recorded in an account held at the second financial institution. The first and second devices each store at least a portion of a program which is run in a synchronized interactive manner between the first devices. The invention extends to a system for implementing the method.

Buchanan et al., U.S. Pat. No. 5,950,179 describes a computer-implemented method for issuing a credit card to a customer who has difficulty qualifying for unsecured credit or who requests a secured credit card. A card request input is received indicating that a customer has made a request for a credit card, and, in response, a credit card account with an initial credit limit is created for the customer. The initial credit limit is stored by computer. A credit card us issued to the customer before receipt of an indication of a deposit to a savings account to secure the credit card. A balance of the savings account is periodically monitored by computer for an initial deposit, and a new credit limit is computed when the initial deposit has been made.

Solokl et al., U.S. Pat. No. 6,173,269 describes a method and apparatus for executing electronic transactions with teens, especially where such transactions are limited only to those vendors that have been approved by the teen's parents. In one embodiment, a virtual automatic teller machine (VATM) is provided in which funds are transferred from an existing account, such as a saving account, checking account, or credit card account, to an Internet passport account. The VATM account mimics a bank account, i.e. it gives the user the appearance of an ATM machine. Functionally, the VATM allows the user to transfer funds from an existing account into the Internet passport account. The VATM does this by emulating an ATM machine as it appears to the Automated Clearing House (ACH) system. The ACH system is a separate network from the Internet. Rather than acting as a trustee for a teen account, the invention provides a method and apparatus that allows a merchant to withdraw funds directly from the teen's account automatically at the time of purchase. In this way, the invention provides a system in which funds are not held, thereby eliminating cash advance fees and liabilities associated with trusteeship. A second embodiment of the invention, a global gift certificate, is provided. The preferred second embodiment of the invention is configured to appear as a debit card to the ACH system. In this regard, the gift certificate thus generated is truly global in that it is accepted anywhere it is presented.

Frisk, U.S. Pat. No. 6,430,406 describes a portable prepaid phone having a display, input means for inputting information and instructions, a control unit controlling the display in dependence on the operation of the input means, and transceiver means communicating via a wireless network controlled by a network operator. The network operator manages an account for said phone and updates the account upon the occurrence of a credit-affecting event. The network operator forwards a credit update message to portable prepaid phone and said message contains information about the current account and the credit affecting event causing the message to be sent to the phone upon the occurrence of a credit affecting event. In the phone the transceiver means receives the credit update message, the control unit decodes the received message in order to identify the content of the credit update message, and the control unit initiates the display of the current account in the display, immediately after the termination of the credit update message decoding.

Joao et al., U.S. Pat. No. 6,529,725 describes a transaction security apparatus and method including an input device for inputting transaction data, a processing device for processing the transaction data and for generating a first signal corresponding to the transaction, and a transmitter for transmitting the first signal over a communication network directly to a communication device associated with an individual account holder. The communication device provides notification to the individual account holder of the transaction.

Cuervo, U.S. 20010047342 describes a credit or debit card of any kind issued by a bank(s) or financial institution which when issued convey an interest earning savings account opened by the same bank issuing the card. The card may be a Credit or Debit card of any kind, including but not limited to: an Affinity Credit Card; a Gift Card; a Prepaid Debit Card; a Stored Value Card; a Corporate Credit or Debit Card; a Bank Card; a Funded Card, et al. This invention will provide the user a Method and System the benefits of an attached savings account which will, by electronic (EFT) transfers, receive the funds developed by discounts, rebates or rebates offered by participating stores and or service provider entities when purchasing their merchandise or services using the card. Users of this Method and System will benefit from discounts, rewards or rebates to which they may not be entitled when using presently credit or debit cards available. The deposited funds, product of discounts, rebates, rewards or additional deposits made by the cardholder to the Savings Account, may be transferred by the cardholder to increase its debit card stored amount or to reduce an owed balance in a credit card. Withdrawal of funds in full when the card is cancelled. A previous bank relationship is unnecessary and not requested to obtain this prepaid or stored value debit card, for credit cards and bank check debit cards may be required a previous bank relationship of an existing or new checking account.

Wilson et al., U.S. 20020169720 describes a method for cardholders to communicate restrictions on card usability in terms of time, amount, number of charges, and merchants to card issuers though dedicated applications on wireless PDA, cell phone, desktop applications, or Web applications, repeatedly and at will, and for card issuers to evaluate future transactions in terms of these restrictions and authorize or decline those transactions based on the results of those evaluations.

Razvan et al., U.S. 20020143703 describes a new type of cash card which is freely transferable, redeemable and usable and which a user can purchase with a set amount of credit thereon and add to the balance as it is used. The card can be used by the bearer with identification which is handled by a central office. The card can be transferred from one user to another with a registration at the central office.

CoinStar, Inc., WO 03/071495 describes methods and systems for exchanging various forms of value, including coins, currency, credit, debit, and/or bank account funds, for prepaid cash cards, credit cards, phone cards and the like (100 and 402). In one embodiment, a value exchange machine includes a coin input region (106), a coin sorting/counting apparatus (112), a card reader (202), and a communications facility (113) configured to communicate with a remote computer network In another embodiment, a value exchange system includes one or more of the value exchange machines connected to one or more remote computers via a communications link (500). A user wishing to purchase, for example, a prepaid cash card can visit one of the value exchange machines, select a desired transaction, and pay for the card with coins, currency, a credit card, a debit card, and/or bank account funds. After confirming payment, the value exchange machine dispenses the card to the user.

The prior art teaches the use of a transaction security apparatus and method, a method for a cardholder to place use restrictions on a credit card, credit cards issued with bank saving accounts attached, funds transfer systems, methods for executing electronic commercial transactions with minors, methods for exchanging and transferring value, credit information in a mobile phone, method for issuing a secured credit card, and an internet cash card, but does not teach a telecommunication method for adjusting a bank account balance when necessary from a remote location and for being alerted when a withdrawal from the account is being made. The present invention fulfills these needs and provides further related advantages as described in the following summary.

### SUMMARY OF THE INVENTION

The present invention teaches certain benefits in construction and use which give rise to the objectives described below.

The present invention is a computer program or digital apparatus instruction set capable of operating an information transfer between a local or remote banking facility and a banking customer with respect to usage of credit cards. The objective is to enable the customer to place into an active account, an active balance in which the user feel comfortable. For example, today it is not uncommon for a credit card holder to have a credit balance of $10,000 or more. Should the card fall into the hands of strangers or otherwise be used fraudulently, a significant amount of credit may be used without the customer's knowledge. In the present method, the customer or user has control over the amount that is placed into his/her active account at any time, so that only that amount is able to be drawn upon as credit. A conservative user may leave the active account balance at zero until a purchase is necessary. A less conservative user may keep the active account balance at a low level, replenishing it as necessary. The active account may be set to zero balance when fraud is suspected.

A primary objective of the present invention is to provide an apparatus and method of use of such apparatus that provides advantages not taught by the prior art.

Another objective is to provide such an invention capable of being used from any location including highly remote locations.

A further objective is to provide such an invention capable of transferring monies from a credit reserve to an active account at a banking facility as the need arises, but only with validation by the approved banking customer.

A still further objective is to provide such an invention capable of thwarting credit card fraud by keeping active banking balances at a low level, when such funds are not needed or by setting them to zero when fraud is discovered, suggested, or found or when a card is lost or stolen.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a logic flow diagram of a first preferred embodiment of the invention which is used when a display device is present such as at a bank or on a computer screen or cell phone screen;

FIG. 2 is a similar diagram describing a further embodiment thereof for use when only an audible connection is available as with a telephone; and

FIG. 3 is a plan view of a credit card used in the instant method.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

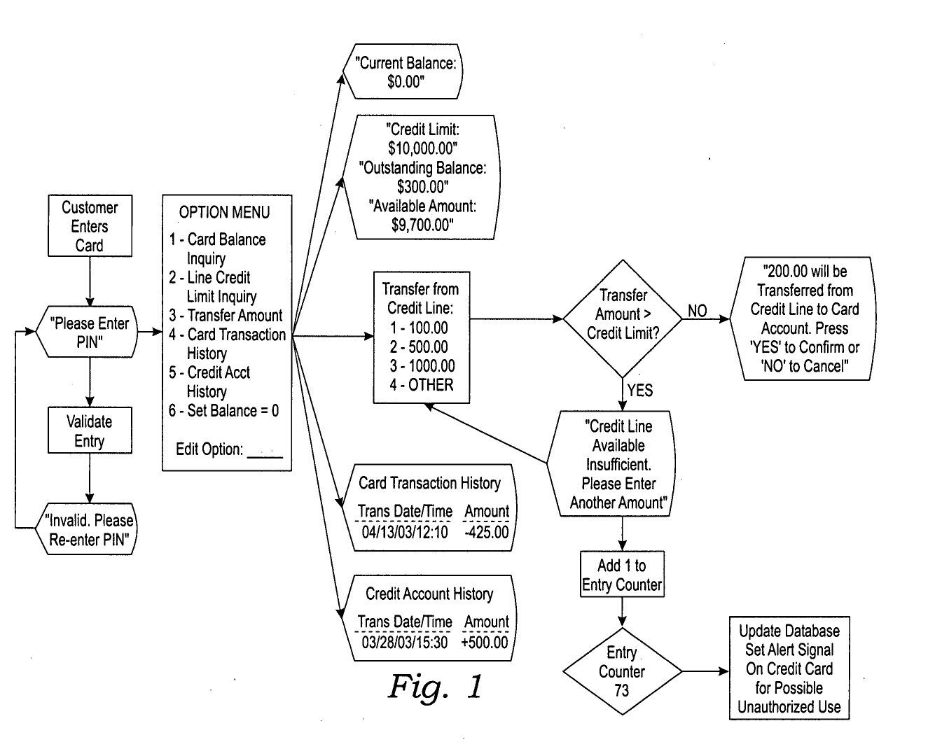

In the embodiment shown in FIG. 1, starting at the upper left in the diagram, a banking customer slides his/her banking card, ATM card or credit card, etc., collectively herein, “credit card,” through a card reader, the card reader has a screen visible to the customer and presents “Please Enter PIN” to the customer. The PIN that is entered is validated by the customer program, in which case an Option Menu is presented on the screen, or it is not validated and the screen presents, “Invalid, Please Re-enter PIN.” This retry loop will continue until a valid PIN is entered so that the customer can be recognized, or until a selected number of retries have been attempted, e.g., usually three. The Option Menu enables one to select a desired edit option, including: 1. Card Balance inquiry, 2. Credit Line Limit Inquiry, 3. Transfer Amount, 4. Card Transaction History, 5. Credit Account History, and 6. Set Balance to Zero. Selection is by touch-sense, using a mouse, track ball, numeric keypad or any other electronic selection method.

For option (1) the current account balance is displayed; for option (2) the credit line limit, outstanding account balance and the net available amount are displayed, where the net available amount it the difference between the credit line limit and the outstanding account balance; for option (3) the user may select from several amounts displayed, the amount desired to be transfered from the credit line to the bank account balance; for option (4) a list of card transaction amounts with corresponding dates and times is displayed; for option (5) a list of credit transfers is displayed in the same manner, and for option (6) active account balances are immediately set to zero.

For option (3) when a transfer amount is selected the program next checks to see if the selected amount is greater than the credit limit. If it is greater, then, “Credit line insufficient, enter a lesser amount,” is presented. If it is not greater, then, the requested amount is stated with a message that the amount will be transferred from the credit line to the card account and a request for verification is made. Such a verification may be entered by the customer from the keypad, with a “y” for yes to proceed, and a “n” for no, to cancel.

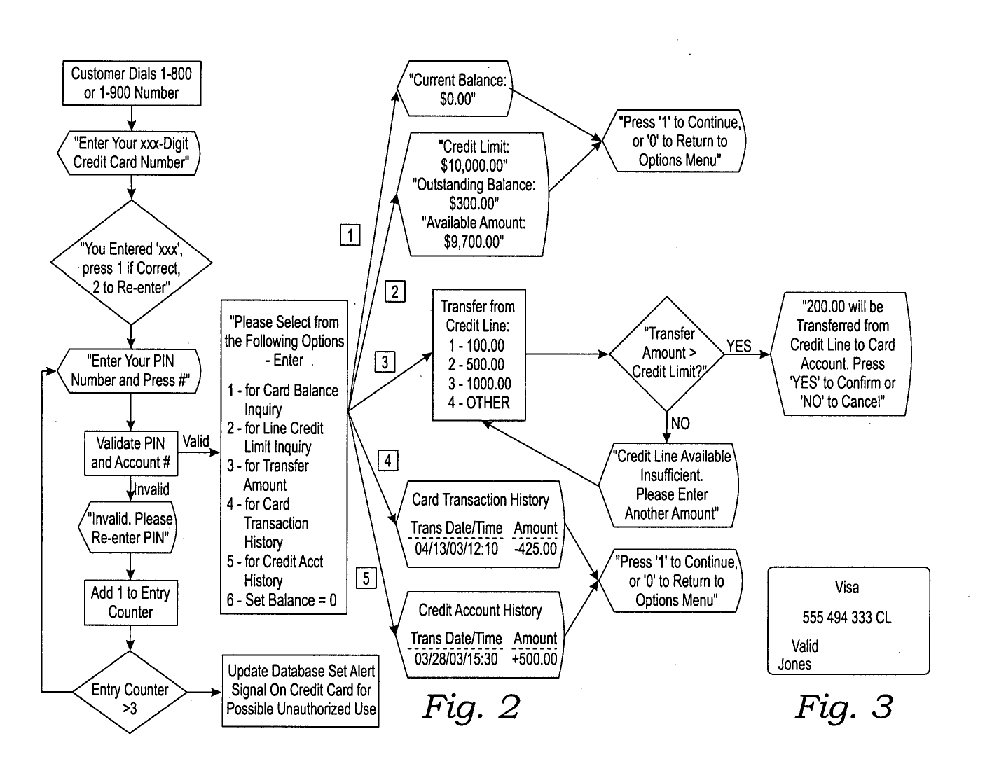

In the embodiment shown in FIG. 2, starting at the upper left in the diagram, a banking customer dials an appropriate phone number from any telecommunications device, e.g., a line phone, a cell phone or any appropriate portable device. The customer hears a recorded response requesting entry of a credit card number which is completed by the customer. The recorded response recites the number entered and asks for confirmation by the customer. Next, in the same manner, the customer is requested and responds by entering a PIN number which is validated or corrected by the customer and thereafter validated. If validation is not possible, an alert is set for possible unauthorized use. Next, as above an Option Menu is presented verbally. The Option Menu enables one to select a desired edit option, including: 1. Card Balance inquiry, 2. Credit Line Limit Inquiry, 3. Transfer Amount, 4. Card Transaction History, 5. Credit Account History, and 6. Set Balance to Zero. Selection is by verbal response or by numeric keypad or any other electronic selection method appropriate to telecommunications.

For option (1) the current account balance is presented audibly; for option (2) the credit line limit, outstanding account balance and the net available amount are presented audibly, where the net available amount is the difference between the credit line limit and the outstanding account balance; for option (3) the user may select from several amounts audibly presented, as the amount desired to be transferred from the credit line to the bank account balance; for option (4) a list of card transaction amounts with corresponding dates and times is audibly presented; for option (5) a list of credit transfers is audibly presented in the same manner and, for option (6) the customer has the ability to verbally request that active account balances be set to zero.

After each presentation the customer is given the chance to press “1” to continue and “0” to return to the Options Menu whereupon the options are recited once again. For option (3) when a transfer amount is requested by the customer the program next checks to see if the selected amount is greater than the credit limit. If it is greater, then, “Credit line insufficient, enter a lesser amount,” is verbally presented. If it is not greater, then, the requested amount is stated with a message that the amount will be transferred from the credit line to the card account and a request for verification is made. Such a verification may be entered by the customer from the keypad, with a “y” for yes to proceed, and a “n” for no, to cancel.

A further improvement in the present invention is the use of an insignia or special mark on the face of a credit card that is used with the method to indicate that the card has a controlled credit limit under use. This insignia may be any symbol or trademark such as “CL” as shown in FIG. 3, indicting the special nature of the card and is used primarily to present a visual element to further avoid potential fraudulent use of the credit card.

The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements.

Changes from the described subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto.

1. A method for establishing control over credit card transactions, the method comprising the steps of: establishing a transaction supporting banking account, a credit limit, and an active account portion of the banking account wherein, credit card transactions are limited to the active account portion through valid requests, wherein each transaction includes, validating a user credit card prior to the transaction; presenting screen options to the user including: Card Balance Inquiry, Credit Line Limit Inquiry, Transfer Amount, Transaction History, Account History, and Set Zero Balance; and selecting one of the options through at least one of a touch sense screen and a keypad; wherein,
a) for Card Balance Inquiry, displaying a balance in the active account;
b) for Credit Line Limit Inquiry, displaying a credit limit and a balance in the active account;
c) for Transfer Amount, displaying possible amount choices;
d) for Transaction History, displaying a list of card transaction amounts with corresponding dates and times of execution;
e) for Account History, displaying a list of credit transfers into the active account with corresponding dates and times of execution, and
f) for Set Zero Balance, setting the active account balance to zero and displaying that the active account balance is zero.

2. The method of claim 1 further comprising the steps of: comparing the requested amount with the credit limit when Transfer Amount is selected; displaying “Credit line insufficient” when the Transfer Amount exceeds the credit limit; and displaying “Requested amount transferred” and a new active account balance when the credit limit exceeds the Transfer Amount.

3. The method of claim 2 further comprising the step of: verification by the user prior to transfer of an accepted amount.

4. A method for establishing control over credit card transactions, the method comprising the steps of: establishing a transaction supporting banking account, a credit limit, and an active account portion of the banking account wherein, credit card transactions are limited to the active account portion through valid requests, wherein each transaction includes, validating a user credit card prior to the transaction; presenting audible options to the user including: Card Balance Inquiry, Credit Line Limit Inquiry, Transfer Amount, Transaction History, Account History, and Set Zero Balance; and selecting one of the options through a keypad; wherein,
a) for Card Balance Inquiry, enunciating a balance in the active account;
b) for Credit Line Limit Inquiry, enunciating a credit limit and a balance in the active account;
c) for Transfer Amount, enunciating possible amount choices;
d) for Transaction History, enunciating a list of card transaction amounts with corresponding dates and times of execution;
e) for Account History, enunciating a list of credit transfers into the active account with corresponding dates and times of execution, and
f) for Set Zero Balance, setting the active account balance to zero and enunciating that the active account has been set to zero.

5. The method of claim 4 further comprising the steps of: comparing the requested amount with the credit limit when Transfer Amount is selected; enunciating “Credit line insufficient” when the Transfer Amount exceeds the credit limit; and enunciating “Requested amount transferred” and a new active account balance when the credit limit exceeds the Transfer Amount.

6. The method of claim 5 further comprising the step of: verification by the user prior to transfer of an accepted amount.

7. The method of claim 4 further comprising the step of placing an insignia on a credit card used with the method to indicate the that the card has a controlled credit limit under use.
